(19) United States
(12) Patent Application Publication
(10) Pub. No.: US 2012/0237246 A1
(43) Pub. Date: Sep. 20, 2012

(54) TONER DENSITY SENSOR AND IMAGE FORMING APPARATUS

(75) Inventors: Yoshitaka Taishi, Shiga (JP); Hajime Kawai, Kyoto (JP)

(73) Assignee: OMRON CORPORATION, Kyoto-shi (JP)

(21) Appl. No.: 13/347,739

(22) Filed: Jan. 11, 2012

(30) Foreign Application Priority Data
Mar. 15, 2011 (JP) 2011-056991

(51) Int. Cl. G03G 15/00

(52) U.S. Cl. 399/74

(57) ABSTRACT

A toner density sensor has a light emitting unit that emits light to detect toner density, a light receiving unit that receives the light emitted from the light emitting unit and reflected from a detection target, and a board on which the light emitting unit and the light receiving unit are surface-mounted. A penetration space that penetrates the board in a thickness direction is formed in at least one of portions in which the light emitting unit and the light receiving unit are attached to the board.

### BACKGROUND OF THE INVENTION

1. Technical Field

The present invention relates to a toner density sensor that is used in an image forming apparatus such as a copying machine, a printer, and a facsimile Machine, particularly to a toner density sensor that can improve detection accuracy.

2. Related Art

The toner density sensor is a main component that is used to acquire optimum image quality in the image forming apparatus. The toner density sensor includes a light emitting unit that emits light, a light receiving unit that receives the light, which is emitted from the light emitting unit and reflected from a detection target, and an amplifying unit that amplifies a detection voltage of the light receiving unit. In the case of an intermediate transfer type image forming apparatus in which a toner image primarily transferred to an intermediate transfer belt is secondarily transferred to a paper sheet, in the toner density sensor, when the light emitting unit emits the light to the intermediate transfer belt, the light receiving unit detects the light reflected from the toner image on the intermediate transfer belt. Toner density adhering to the intermediate transfer belt is detected based on a photocurrent (detection voltage) generated in the light receiving unit, and a necessary correction is optically or electrically performed based on a detection result of the toner density.

However, the light emitting unit and the light receiving unit of the toner density sensor are surface-mounted on a printed board, and the light is emitted from the light emitting unit in directions except a desired direction.

Therefore, noise light is generated. The noise light is also called stray light, which causes degradation of the detection accuracy. Not only the light emitted from the light emitting unit surface-mounted on the board travels toward the desired detection target, but also the light invades in the board. In the board made of paper and a phenol resin or glass and an epoxy resin or the like, the light travels while being reflected, and the light reaches a surrounding area of the light receiving unit. As a result, a noise is generated in the detection voltage of the light receiving unit, and the detection is hardly performed with high accuracy.

For example, Japanese Unexamined Patent Publication No. 2009-58520 discloses a toner density sensor.

In the configuration of Japanese Unexamined Patent Publication No. 2009-58520, an elongate slit-shaped through-hole is provided between the light emitting unit and the light receiving unit, which are surface-mounted on the board of the sensor.

The light that invades and propagates in the board from the light emitting unit is eliminated such that the light passes through the through-hole, thereby reducing the noise light reaching the light receiving unit.

According to the configuration of Japanese Unexamined Patent Publication No. 2009-58520, the noise light can be reduced. However, it is necessary to ensure an area in which the through-hole is made (see FIG. 4 of Japanese Unexamined Patent Publication No. 2009-58520). Therefore, as illustrated in a toner density sensor 101 in FIG. 15, the configuration of Japanese Unexamined Patent Publication No. 2009-58520 cannot be adopted in a case where a light emitting unit 102 and light receiving units 103 and 104 are brought close to each other in order to achieve miniaturization. In FIG. 15, the numeral 105 designates a printed board, the numeral 106 designates a case, and the numeral 107 designates a lens.

### SUMMARY

One or more embodiments of the present invention prevents the degradation of the detection accuracy, which is caused by the noise light, even in a close distance between the light emitting unit and the light receiving unit.

In accordance with one or more embodiments of the present invention, a toner density sensor includes: a light emitting unit that emits light in order to detect toner density; and a light receiving unit that receives the light, which is emitted from the light emitting unit and reflected from a detection target, wherein the light emitting unit and the light receiving unit are surface-mounted on a board, and a penetration space that penetrates the board in a thickness direction is formed in at least one of portions in which the light emitting unit and the light receiving unit are attached to the board.

In the configuration of the toner density sensor, when the penetration space is formed in the portion in which the light emitting unit is attached to the board, the light that is emitted from the light emitting unit to possibly become the noise light radiates to the outside through the penetration space, and the light propagating in the board is reduced. When the penetration space is formed in the portion in which the light receiving unit is attached to the board, the noise light that propagates in the board to reach the light receiving unit is diffused by the inside surface of the penetration space, and the noise light reaching the light receiving unit is reduced.

According to one or more embodiments of the invention, the penetration space prevents the noise light from being generated or reaching the light receiving element, so that the detection accuracy of the light receiving unit can be, improved. The penetration space is formed in the portion in which the surface-mounted light emitting unit or light receiving unit is attached to the board, so that the necessity to ensure the additional flat surface is eliminated, and the small area can effectively be utilized. Therefore, one or more embodiments of the invention can suitably be applied to the small-size toner density sensor.

### BRIEF DESCRIPTION OF THE DRAWINGS

FIG. 1 is a perspective view of a toner density sensor;

FIG. 2A is a front view schematically illustrating the toner density sensor, and FIG. 2B is a sectional view schematically illustrating the toner density sensor;

FIG. 3 is a schematic configuration diagram of an image forming apparatus;

FIG. 4A is a plan view illustrating a structure of the toner density sensor, and FIGS. 4B and 4C are sectional views illustrating the structure of the toner density sensor;

FIG. 5 is a plan view illustrating another example of the printed board;

FIG. 6 is a sectional view illustrating another example of the toner density sensor;

FIG. 7 is a sectional view illustrating still another example of the toner density sensor;

FIG. 8 is a sectional view illustrating still another example of the toner density sensor;

FIG. 9A is a plan view illustrating still another example of the structure of a toner density sensor, and FIGS. 9B and 9C are sectional views illustrating still another example of the structure of the toner density sensor;

FIG. 10 is a sectional view illustrating still another example of the toner density sensor;

FIG. 11A is a plan view illustrating still another example of the structure of a toner density sensor, and FIGS. 11B and 11C are sectional views illustrating still another example of the structure of the toner density sensor;

FIG. 12A is a plan view illustrating still another example of the structure of a toner density sensor, and FIGS. 12B and 12C are sectional views illustrating still another example of the structure of the toner density sensor;

FIG. 13 is a sectional view illustrating still another example of the toner density sensor;

FIG. 14 is a sectional view illustrating still another example of the toner density sensor; and

FIG. 15 is a transverse sectional view illustrating a case portion of a conventional toner density sensor.

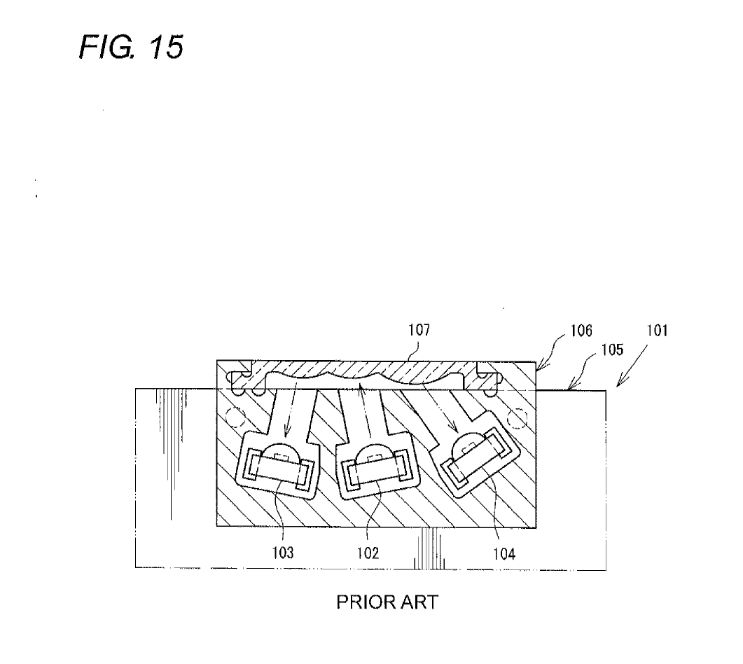

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

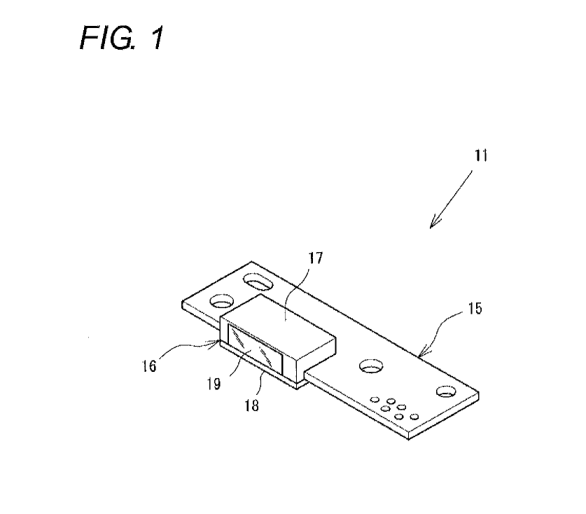

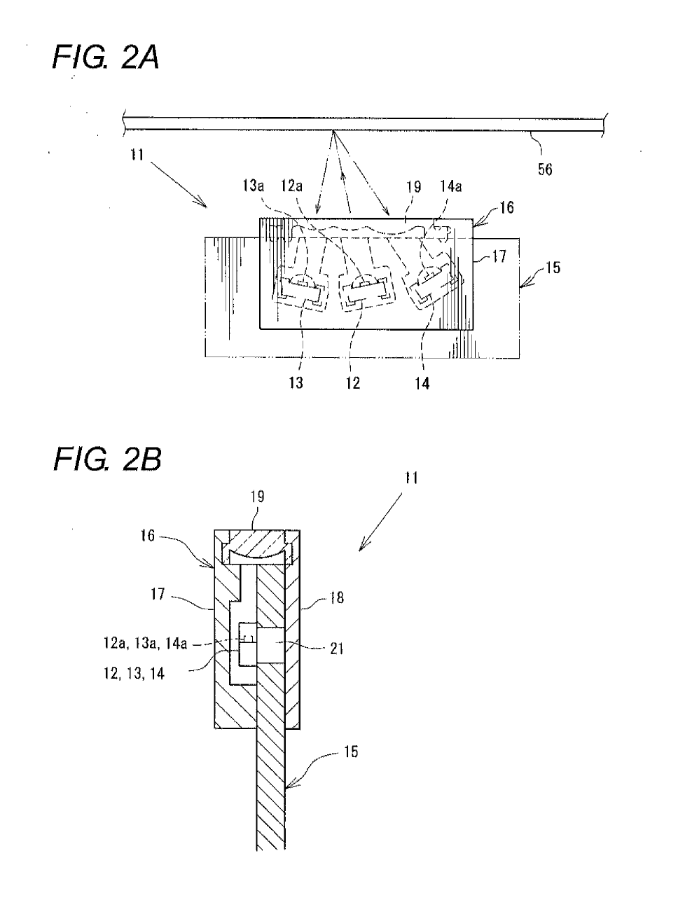

FIG. 1 is a perspective view of a toner density sensor 11, and FIG. 2 is an explanatory view illustrating a schematic structure of the toner density sensor 11.

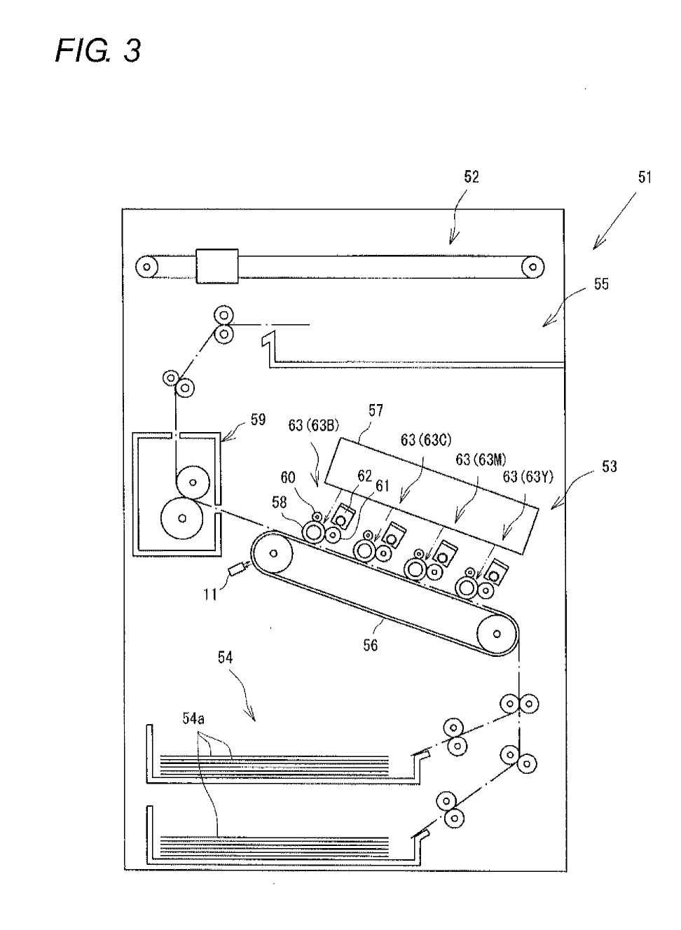

The toner density sensor 11 is mounted on an image forming apparatus 51 illustrated in FIG. 3. For example, the image forming apparatus 51 is a color laser printer. The schematic structure of the image forming apparatus 51 will be described below.

The image forming apparatus 51 includes an original reading unit 52 that is provided in an upper portion thereof, an image forming unit 53, a sheet feed unit 54 that is provided in a lower portion, and a sheet discharge unit 55 that is provided in the upper portion. In the image forming apparatus 51, the image forming unit 53 forms an image based on original data read with the original reading unit 52, the image is transferred to a paper sheet 54a supplied from the sheet feed unit 54, and the paper sheet 54a is discharged from the sheet discharge unit 55. A transfer belt 56 is tensioned in the image forming unit 53. Toner adheres to a photosensitive drum 58 that is exposed to light from a light writing device 57, and the toner is primarily transferred to the transfer belt 56 to form the image. When the paper sheet 54a is supplied, the image is secondarily transferred from the transfer belt 56 to the paper sheet 54a. Then the paper sheet 54a is conveyed to a fixing unit 59, and the toner is fixed to the paper sheet 54a by heat and a pressure.

An image forming unit 63 includes a charging roller 60, a development sleeve 61, a toner case 62, and the photosensitive drum 58. In the image forming unit 63, a yellow image forming unit 63Y, a magenta image forming unit 63M, a cyan image forming unit 63C, and a black image forming unit 63B are provided.

The toner density sensor 11 is provided opposite the transfer belt 56 in the image forming apparatus 51, and detects the toner density on the transfer belt 56. The toner density sensor 11 may be provided in the image forming unit 63. In this case, the toner density sensor 11 detects the toner density on the photosensitive drum 58.

The toner density sensor 11 will be described below.

As illustrated in FIG. 2A, the toner density sensor 11 includes a light emitting element 12 that is the light emitting unit emitting the light, light receiving elements 13 and 14 that are the light receiving unit receiving the light, which is emitted from the light emitting element 12 and reflected from the transfer belt 56 that is the detection target, and an amplifier circuit (not illustrated) that amplifies detection voltages of the light receiving elements 13 and 14. For example, a light emitting diode is used as the light emitting element 12, and a phototransistor or a photodiode is used as the light receiving elements 13 and 14.

The light emitting element 12 and the light receiving elements 13 and 14 are surface-mounted on a printed board 15 (see FIG. 2B).

A portion in which the light emitting element 12 and the light receiving elements 13 and 14 are mounted is covered with a case 16. As illustrated in FIGS. 1 and 2B, the case 16 includes an upper case 17 and a lower case 18, and a lens member 19 is retained in a portion on an edge side of the printed board. The side on which the light emitting element 12 and the light receiving elements 13 and 14 are mounted is covered with the upper case 17, and a surface on the opposite side of the printed board 15 is covered with the lower case 18.

Specifically, as illustrated by a broken line of FIG. 2A, the light emitting element 12 and the light receiving elements 13 and 14 are disposed on the substantially straight line. In the light receiving elements 13 and 14, the first light receiving element 13 located on the left side in FIG. 2A receives the regularly reflected light in the light, which is emitted from the light emitting element 12 and reflected from the transfer belt 56, and the first light receiving element 13 mainly detects the density of black toner. In the light receiving elements 13 and 14, the second light receiving element 14 located on the right side in FIG. 2A receives the diffusely reflected light in the light, which is emitted from the light emitting element 12 and reflected from the transfer belt 56, and the second light receiving element 14 mainly detects the density of yellow, magenta, and cyan color toner.

As illustrated in FIG. 2B, in order to improve the detection accuracy, the toner density sensor 11 has a configuration in which a penetration space 21 that penetrates the printed board 15 in a thickness direction is formed in a portion in which at least one of the light emitting element 12 and the light receiving elements 13 and 14 is attached to the printed board 15. The penetration space 21 prevents the generation of the noise light invading in the printed board 15, or prevents the noise light invading in the printed board 15 from reaching the light receiving elements 13 and 14.

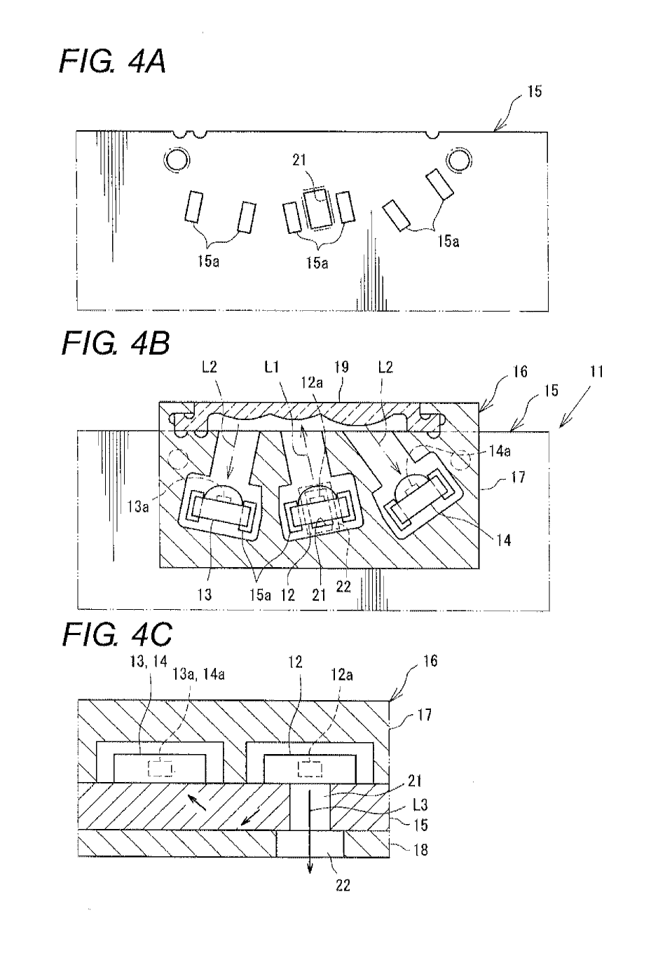

The toner density sensor 11 is configured as illustrated in FIG. 4 when the penetration space 21 is formed in the portion in which the light emitting element 12 is attached to the printed board 15. A wiring pattern except a land 15a that is a soldering copper foil used to mount the light emitting element 12 and the light receiving elements 13 and 14 on the surface of the printed board 15 is not illustrated in FIG. 4. The same holds true for the following drawings.

As illustrated in FIG. 4A, the hole-shaped penetration space 21, which penetrates the printed board 15 in the thickness direction, is formed in the portion in which the light emitting element 12 is attached. The penetration space 21 has a rectangular shape, when viewed from the above. The penetration space 21 is formed while including a portion corresponding to a chip 12a of the light emitting element 12 (see FIGS. 4b and 4c).

A shape and a size of the penetration space 21 are properly set, and it is only necessary to form the penetration space 21 in the portion corresponding to the chip 12a of the light emitting element 12. In the case of the small-size penetration space 21, the penetration space 21 may be formed around a region corresponding to the chip 12a.

The shape and the size of the penetration space 21 are properly set in consideration of the land 15a.

The penetration space 21 is not formed in the portions in which the first light receiving element 13 and the second light receiving element 14 are attached.

In the case 16, a through-hole 22, which is the hole portion penetrating the printed board 15 in the thickness direction, is also made in the lower case 18 with which the lower surface of the printed board 15 is covered. As illustrated in FIGS. 4B and 4C, the through-hole 22 is made in the region corresponding to the penetration space 21 of the printed board 15.

In FIGS. 4B and 4C, the through-hole 22 in the lower case 18 is made larger than the penetration space 21 of the printed board 15. Alternatively, the through-hole 22 may be made equal to or smaller than the penetration space 21.

FIG. 4B is a transverse sectional view illustrating the upper case 17 in the toner density sensor 11, in which the light emitting element 12 and the light receiving elements 13 and 14 are surface-mounted and the case 16 is attached.

In the toner density sensor 11 having the above configuration, the light emitted from the light emitting element 12 travels toward the direction of the lens member 19 as illustrated in FIG. 4B, and the light also travels in the direction of the printed board 15 as illustrated in FIG. 4C.

Emitted light L1 travelling in the direction of the lens member 19 is transmitted through the lens member 19, and reflected by the transfer belt 56. Reflected light L2 is received by the light receiving elements 13 and 14 through the lens member 19. In FIG. 4C, only the first light receiving element 13 is illustrated while the second light receiving element 14 is not illustrated. However, the same holds true for the second light receiving element 14. The same holds true for the following drawings.

Based on a detection voltage of the reflected light L2, the toner density is detected as described above.

On the other hand, the light travelling from the light emitting element 12 in the direction of the printed board 15 radiates to the outside through the penetration space 21 of the printed board 15 and the through-hole 22 of the lower case 18.

Although part of the emitted light invades in the printed board 15, since emitted light L3 travelling in the direction of the printed board 15 radiates substantially from the penetration space 21, the amount of noise light invading in the printed board 15 can be reduced. Even if the small amount of noise light invades in the printed board 15, the light attenuates in time. As a result, the noise light reaching the light receiving elements 13 and 14 is significantly reduced.

Accordingly, the light receiving elements 13 and 14 are hardly influenced by the noise light, and the improvement of the detection accuracy can be achieved.

The penetration space 21 is formed in the portion in which the light emitting element 12 is attached. In the printed board 15, because of the structure in which the penetration space 21 is formed below the light emitting element 12, the necessity of the additional flat surface in which the penetration space 21 is provided is eliminated, and the small area can effectively be utilized. Therefore, the high-detection-accuracy, small-size toner density sensor 11 can be obtained.

Since the through-hole 22 is made in the lower case 18, the light emitted from the light emitting element 12 further radiates to the outside, and the light that possibly becomes the noise light can be reduced.

The toner density sensor 11 has the high detection accuracy, so that the high-quality image can be formed in the image forming apparatus 51 on which the toner density sensor 11 is mounted. Additionally, the toner density sensor 11 can be miniaturized, the restricted space of the image forming apparatus 51 can effectively be utilized to contribute to the provision of the better image forming apparatus.

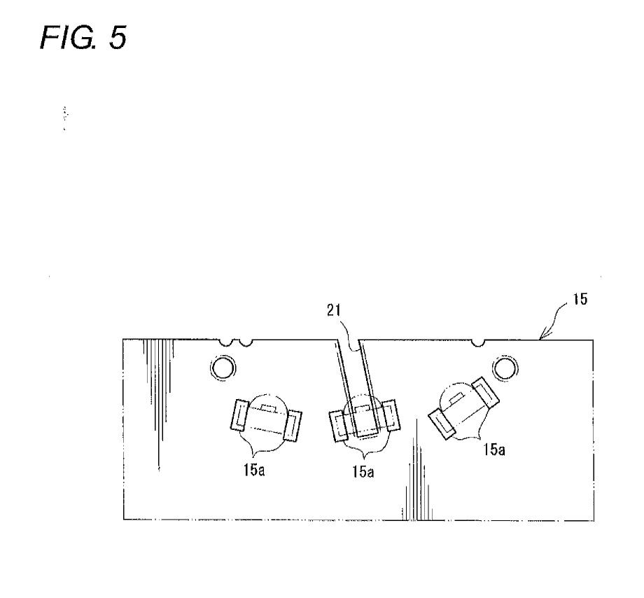

FIG. 5 illustrates another example of the penetration space 21. Not only the penetration space 21 formed into the hole shape, the whole circumference of which is surrounded, the penetration space 21 may be formed into a shape in which the penetration space 21 reaches an end surface of the printed board 15, in other words, a shape in which the penetration space 21 is formed by cutting the printed board 15 from the end surface.

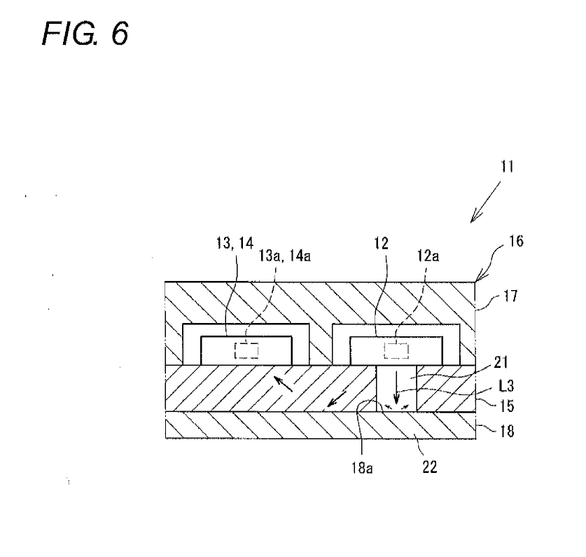

FIG. 6 illustrates still another example in which the through-hole 22 is not made in the lower case 18. When the through-hole 22 is not made in the lower case 18, according to one or more embodiments of the present invention, a surface 18a on the side of the printed board 15 in the region corresponding to the penetration space 21 has a matte black color. The matte black color can absorb the emitted light L3 passing through the penetration space 21, and reduce the light that possibly becomes the noise light.

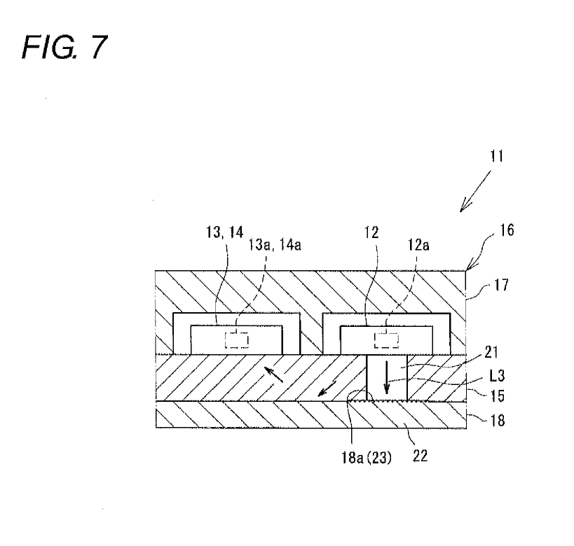

As illustrated in FIG. 7, a graining portion 23 may be formed in the surface 18a on the side of the printed board 15 in the region corresponding to the penetration space 21. The graining portion 23 can absorb the emitted light L3 passing through the penetration space 21, and reduce the light that possibly becomes the noise light. The light absorption effect can further be enhanced by a combination of the use of the black color and the formation of the graining portion 23.

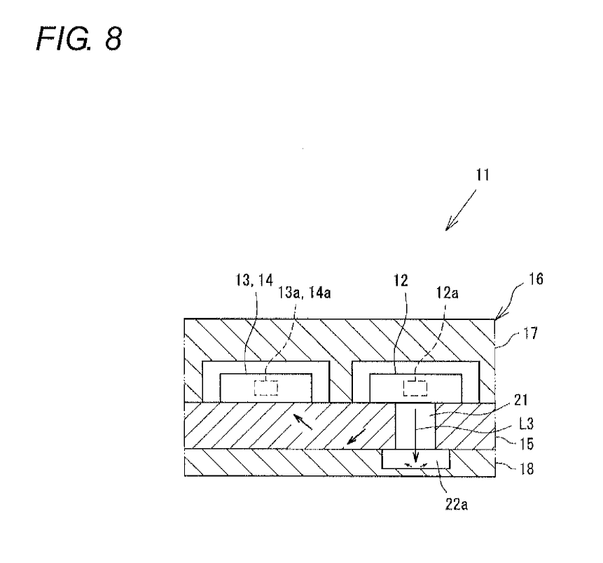

As illustrated in FIG. 8, the hole portion of the lower case 18 may be a hole portion 22a constructed by a recess that does not penetrate the lower case 18 in the thickness direction. In this case, the generation of the noise light can further be reduced by the use of the black color or the formation of the graining portion 23.

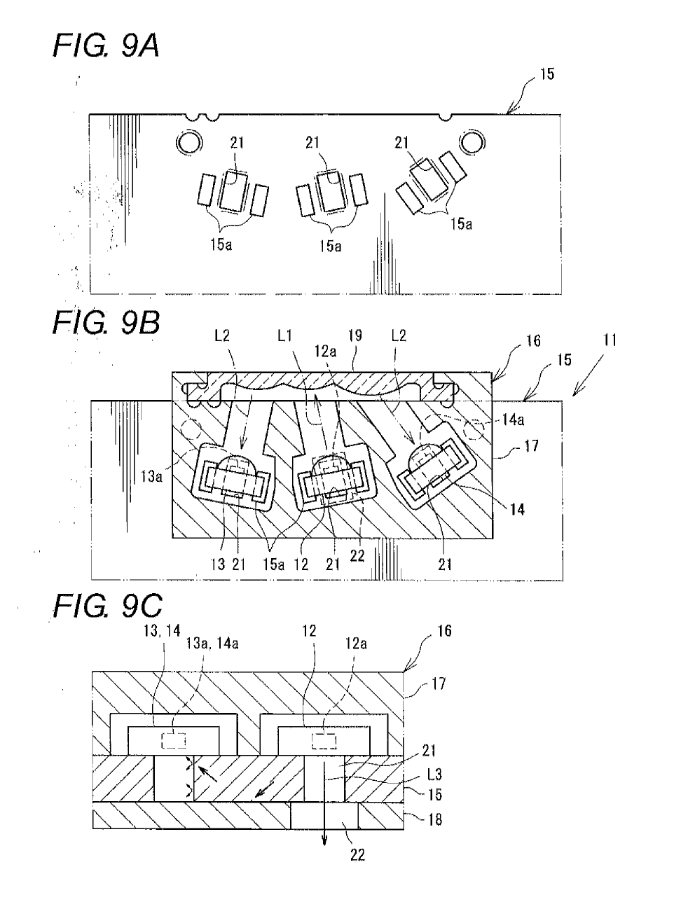

As illustrated in FIG. 9, the penetration spaces 21 are formed in the portions in which the light receiving elements 13 and 14 are attached to the printed board 15 in addition to the portion in which the light emitting element 12 is attached.

As illustrated in FIG. 9A, the hole-shaped penetration spaces 21 are formed in the portions in which the light emitting element 12 and the light receiving elements 13 and 14 are attached. The penetration spaces 21 have a rectangular shape when viewed from above, and penetrate the printed board 15 in the thickness direction. The penetration spaces 21 are formed while including the portions corresponding to chips 12a, 13a, and 14a of the light emitting element 12 and the light receiving elements 13 and 14, and the detail of the penetration space 21 is described above.

In the case 16, the through-hole 22, which is the hole portion penetrating the printed board 15 in the thickness direction, is also made in the lower case 18 with which the lower surface of the printed board 15 is covered. As illustrated in FIGS. 9B and 9C, the through-hole 22 is made only in the region corresponding to the penetration space 21 that is formed below the light emitting element 12 of the printed board 15. This is because the light is prevented from invading in the light receiving elements 13 and 14 from the outside of the lower case 18.

In the case where the hole portion is made in the region corresponding to the penetration space 21 below the light receiving elements 13 and 14, the hole portion 22a (see, FIG. 8) constructed by the recess that does not penetrate the lower case 18 in the thickness direction as illustrated in FIG. 8. In this case, the generation of the noise light can further be reduced by the use of the black color or the formation of the graining portion 23 (see FIG. 7).

Even in the toner density sensor 11 having the above configuration, not only the light emitted from the light emitting element 12 travels in the direction of the lens member 19 as illustrated in FIG. 9B, but also the light travels in the direction of the printed board 15 as illustrated in FIG. 9C.

As described above, the emitted light L1 travelling in the direction of the lens member 19 is transmitted through the lens member 19 and reflected by the transfer belt 56, and the reflected light L3 is received by the light receiving elements 13 and 14 through the lens member 19, thereby detecting the toner density.

On the other hand, the emitted light L3 travelling from the light emitting element 12 in the direction of the printed board 15 radiates to the outside through the penetration space 21 of the printed board 15 and the through-hole 22 of the lower case 18.

Although part of the emitted light invades in the printed board 15, because the emitted light L3 travelling in the direction of the printed board 15 radiates substantially from the penetration space 21, the amount of noise light invading in the printed board 15 can be reduced. Even if the small amount of noise light invades in the printed board 15, the light attenuates in time. Since the penetration spaces 21 are also formed in the portions in which the light receiving elements 13 and 14 are attached, the noise light diffuses and attenuates in the inside surfaces of the penetration spaces 21. Because the penetration space 21 is formed by pressing (punching) or drilling, the smooth cut surface is not obtained, but the cut surface has an irregular surface. Therefore, the noise light reaching the light receiving elements 13 and 14 is significantly reduced.

Accordingly, the light receiving elements 13 and 14 are hardly influenced by the noise light, and the improvement of the detection accuracy can be achieved.

The penetration spaces 21 are formed in both the portion in which the light emitting element 12 is attached and the portions in which the light receiving elements 13 and 14 are attached. In the printed board 15, because of the structure in which the penetration spaces 21 are formed below the light emitting element 12 and the light receiving elements 13 and 14, the necessity of the additional flat surface in which the penetration spaces 21 are provided is eliminated, and the small area can effectively be utilized. Therefore, the high-detection-accuracy, small-size toner density sensor 11 can be obtained.

In the lower case 18, because the through-hole 22 is not made below the light receiving elements 13 and 14 while the through-hole 22 is made below the light emitting element 12, the large amount of light emitted from the light emitting element 12 radiates to the outside, and the noise light reaching the light receiving elements 13 and 14 can significantly be reduced while the light that possibly becomes the noise light is further reduced.

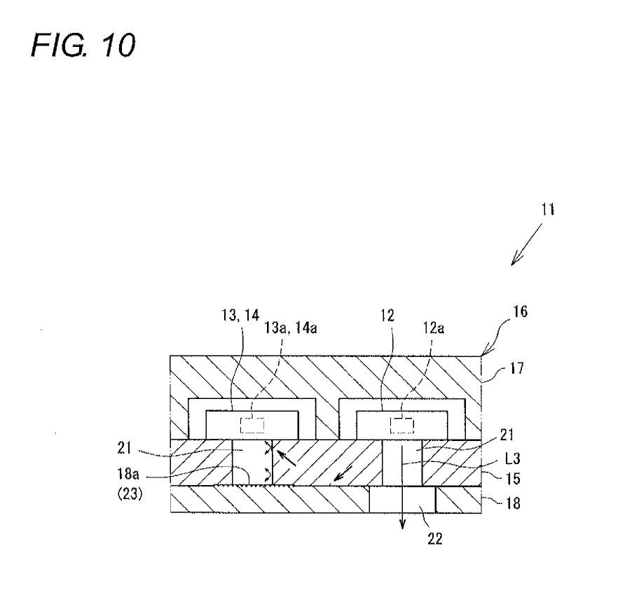

FIG. 10 illustrates another example of the lower case 18. The graining portions 23 are formed in the surface 18a on the side of the printed board 15 in the regions corresponding to the penetration spaces 21 formed below the light receiving elements 13 and 14. Therefore, the noise light invading in the penetration spaces 21 below the light receiving elements 13 and 14 can be prevented from being reflected again. As a result, the light receiving elements 13 and 14 can successfully be protected from the noise light.

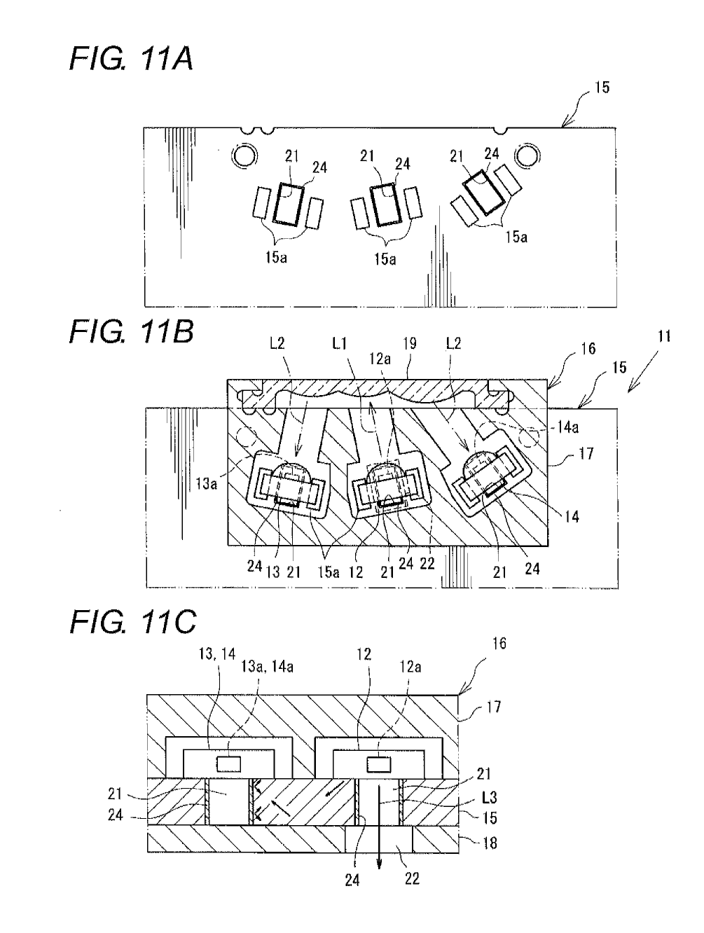

As illustrated in FIG. 11, when a plated layer 24 is formed in the inside surface of the penetration space 21, the effect that prevents the generation of the noise light and the effect that prevents the noise light from reaching the light receiving elements 13 and 14 can be enhanced.

That is, as illustrated in FIGS. 11A and 11C, the plated layers 24 are formed in the inside surfaces of the penetration spaces 21 formed below the light emitting element 12 and the light receiving elements 13 and 14. The plated layer 24 can be formed by the same forming as that of the case in which usually the through-hole is made.

Because the light is blocked by the plated layer 24 in the inside surface of the penetration space 21, the noise light that invades in the printed board 15 from the penetration space 21 can successfully be reduced in the penetration space 21 below the light emitting element 12. The transmission of the noise light that propagates in the printed board 15 to go out to the penetration space 21 can be prevented in the penetration spaces 21 below the light receiving elements 13 and 14. Therefore, the noise light reaching the light receiving elements 13 and 14 is significantly reduced.

The plated layer 24 can also play the same role to prevent the generation of the noise light when the penetration space 21 is formed only below the light emitting element 12 as illustrated in FIG. 4.

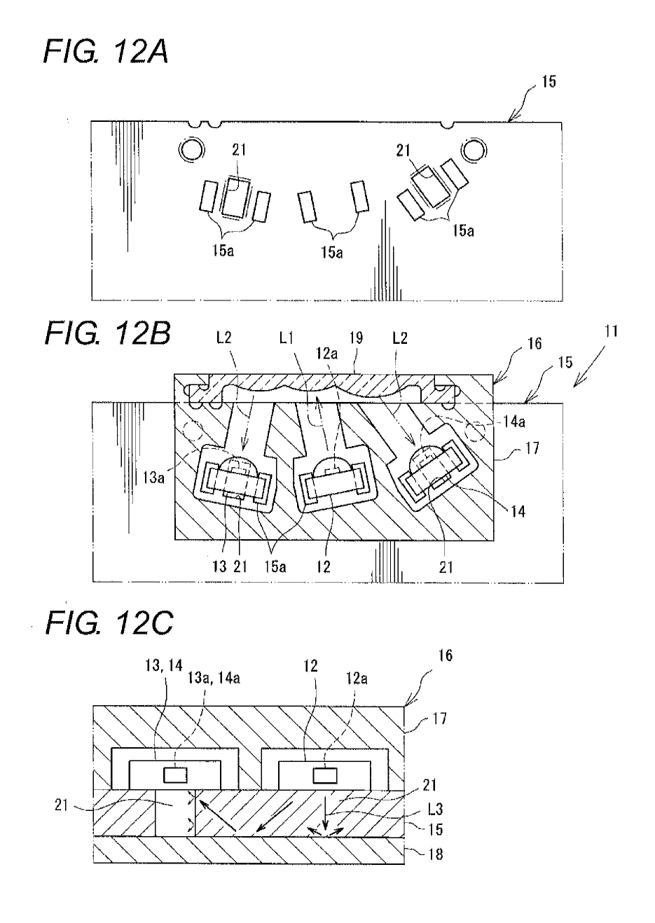

As illustrated in FIG. 12, the penetration spaces 21 are formed in the portions in which the light receiving elements 13 and 14 are attached.

As illustrated in FIG. 12A, the hole-shaped penetration spaces 21 are formed in the portions in which the light receiving elements 13 and 14 are attached. The penetration spaces 21 have the rectangular shape when viewed from above, and penetrate the printed board 15 in the thickness direction. The penetration spaces 21 are formed while including the portions corresponding to chips 13a and 14a of the light receiving elements 13 and 14, and the detail of the penetration space 21 is described above.

The hole portion is not made in the case 16. As needed basis, the surface on the side of the printed board 15 in the region corresponding to the penetration space 21 may be formed in the matte black color, or the graining portion 23 may be made in the surface on the side of the printed board 15 in the region corresponding to the penetration space 21.

In the toner density sensor 11 having the above configuration, the light emitted from the light emitting element 12 travels toward the direction of the lens member 19 as illustrated in FIG. 12B, and the light also travels in the direction of the printed board 15 as illustrated in FIG. 12C.

As described above, the emitted light L1 travelling in the direction of the lens member 19 is transmitted through the lens member 19 and reflected by the transfer belt 56, and the reflected light L2 is received by the light receiving elements 13 and 14 through the lens member 19, thereby detecting the toner density.

On the other hand, the emitted light L3 travelling from the light emitting element 12 in the direction of the printed board 15 invades in the printed board 15, and propagates onto the sides of the light receiving elements 13 and 14 while being reflected or attenuated by a boundary surface between the printed board 15 and the lower case 18. However, since the penetration spaces 21 are formed in the portions in which the light receiving elements 13 and 14 are attached, the noise light diffuses and attenuates in the irregularity of the inside surface of the penetration space 21. Therefore, the noise light reaching the light receiving elements 13 and 14 can be prevented.

Accordingly, the light receiving elements 13 and 14 are hardly influenced by the noise light, and the improvement of the detection accuracy can be achieved.

The penetration spaces 21 are formed in the portions in which the light receiving elements 13 and 14 are attached. In the printed board 15, because of the structure in which the penetration spaces 21 are formed below the light receiving elements 13 and 14, the necessity of the additional flat surface in which the penetration spaces 21 are provided is eliminated, and the small area can effectively be utilized. Therefore, the high-detection-accuracy, small-size toner density sensor 11 can be obtained.

In the lower case 18, the hole portion is not made in the regions corresponding to the penetration spaces 21 below the light receiving elements 13 and 14, so that the noise light can be prevented from invading from the outside.

As described above, the noise light reaching the light receiving elements 13 and 14 is significantly reduced.

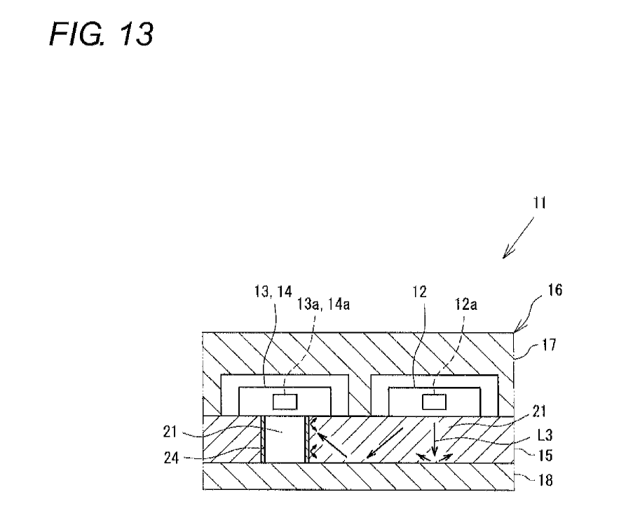

When the penetration spaces 21 are formed only in the portions in which the light receiving elements 13 and 14 are attached, the plated layer 24 may be formed in the inside surface of the penetration space 21 as illustrated in FIG. 13. This is because the noise light can be prevented from invading in the penetration space 21 from the inside of the printed board 15.

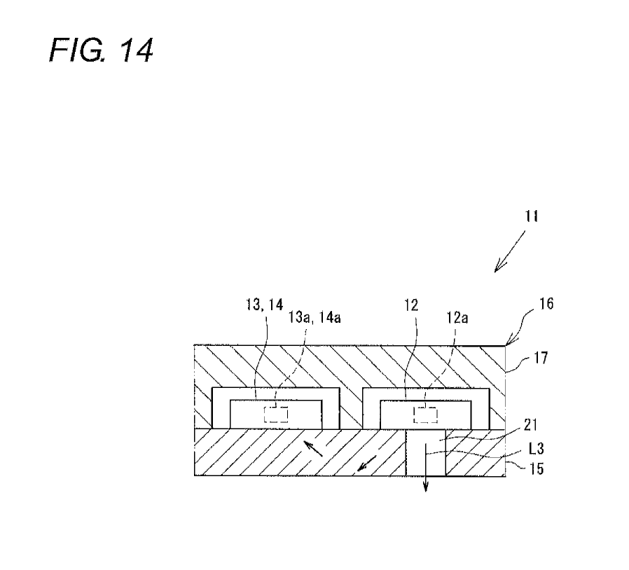

As illustrated in FIG. 14, some of the toner density sensors 11 do not include the lower case 18. In such cases, although the noise light reducing effect is not obtained by the hole portion, the black color, and the graining portion 23 of the lower case 18, the adverse effect of the noise light can be reduced by the penetration space 21 that is formed in the portion in which at least one of the light emitting element 12 and the light receiving elements 13 and 14 is attached.

In one or more embodiments of the present invention, the light emitting unit corresponds to the light emitting element 12, the light receiving unit corresponds to the light receiving element (the first light receiving element 13 and the second light receiving element 14), the board corresponds to the printed board 15, the hole portion corresponds to the through-hole 22 and the hole portion 22a. However, the invention is not limited to the above embodiments, and another configuration may be adopted.

In one or more embodiments, by way of example, the light emitting element 12 and the light receiving elements 13 and 14 are disposed on the same substantially straight line in order to achieve the small-size toner density sensor 11. Alternatively, for example, the light emitting element 12 and the light receiving elements 13 and 14 may be disposed into a V-shape in the toner density sensor. In this case, similarly the improvement of the detection accuracy can be achieved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.
11 TONER DENSITY SENSOR
12 LIGHT EMITTING ELEMENT
13 FIRST LIGHT RECEIVING ELEMENT
14 SECOND LIGHT RECEIVING ELEMENT
12a, 13a, 14a CHIP
15 PRINTED BOARD
16 CASE
18a SURFACE ON BOARD SIDE IN REGION CORRESPONDING TO PENETRATION SPACE
21 PENETRATION SPACE
22 THROUGH-HOLE
22a HOLE PORTION
23 GRAINING PORTION
24 PLATED LAYER
51 IMAGE FORMING APPARATUS

1. A toner density sensor comprising:
a light emitting unit that emits light to detect toner density;
a light receiving unit that receives the light emitted from the light emitting unit and reflected from a detection target; and
a board on which the light emitting unit and the light receiving unit are surface-mounted,
wherein a penetration space that penetrates the board in a thickness direction is formed in at least one of portions in which the light emitting unit and the light receiving unit are attached to the board.

2. The toner density sensor according to claim 1, wherein the penetration space is formed around a region corresponding to a chip portion of the light emitting unit or the light receiving unit.

3. The toner density sensor according to claim 1, wherein a plated layer is formed in an inside surface of the penetration space.

4. The toner density sensor according to claim 1, wherein a case with which the light emitting unit and the light receiving unit are covered is provided in the board, and a hole portion is made in a region corresponding to the penetration space in the case.

5. The toner density sensor according to claim 4, wherein the hole portion is a through-hole that penetrates the board in the thickness direction.

6. The toner density sensor according to claim 1, wherein a case with which the light emitting unit and the light receiving unit are covered is provided in the board, and a surface on the board side in a region corresponding to the penetration space in the case has a matt black color.

7. The toner density sensor according to claim 1, wherein a case with which the light emitting unit and the light receiving unit are covered is provided in the board, and a graining portion is formed in a surface on the board side in a region corresponding to the penetration space in the case.

8. An image forming apparatus on which the toner density sensor according to claim 1 is mounted.

9. The toner density sensor according to claim 2, wherein a plated layer is formed in an inside surface of the penetration space.

10. The toner density sensor according to claim 2, wherein a case with which the light emitting unit and the light receiving unit are covered is provided in the board, and a hole portion is made in a region corresponding to the penetration space in the case.

11. The toner density sensor according to claim 3, wherein a case with which the light emitting unit and the light receiving unit are covered is provided in the board, and a hole portion is made in a region corresponding to the penetration space in the case.

12. The toner density sensor according to claim 9, wherein a case with which the light emitting unit and the light receiving unit are covered is provided in the board, and a hole portion is made in a region corresponding to the penetration space in the case.

13. The toner density sensor according to claim 10, wherein the hole portion is a through-hole that penetrates the board in the thickness direction.

14. The toner density sensor according to claim 11, wherein the hole portion is a through-hole that penetrates the board in the thickness direction.

15. The toner density sensor according to claim 12, wherein the hole portion is a through-hole that penetrates the board in the thickness direction.

16. The toner density sensor according to claim 2, wherein a case with which the light emitting unit and the light receiving unit are covered is provided in the board, and a surface on the board side in a region corresponding to the penetration space in the case has a matt black color.

17. The toner density sensor according to claim 3, wherein a case with which the light emitting unit and the light receiving unit are covered is provided in the board, and a surface on the board side in a region corresponding to the penetration space in the case has a matt black color.

18. The toner density sensor according to claim 9, wherein a case with which the light emitting unit and the light receiving unit are covered is provided in the board, and a surface on the board side in a region corresponding to the penetration space in the case has a matt black color.

19. The toner density sensor according to claim 2, wherein a case with which the light emitting unit and the light receiving unit are covered is provided in the board, and a graining portion is formed in a surface on the board side in a region corresponding to the penetration space in the case.

20. The toner density sensor according to claim 3, wherein a case with which the light emitting unit and the light receiving unit are covered is provided in the board, and a graining portion is formed in a surface on the board side in a region corresponding to the penetration space in the case.
